(19) United States
(12) Patent Application Publication
(10) Pub. No.: US 2007/0120102 A1
(43) Pub. Date: May 31, 2007

(54) Air jack

(75) Inventor: Craig A. Kaplenski, Jackson, SC (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Patent Creators LLC

(21) Appl. No.: 11/439,739

(22) Filed: May 23, 2006

Related U.S. Application Data
(60) Provisional application No. 60/684,009, filed on May 23, 2005.

(51) Int. Cl. B66F 3/35

(52) U.S. Cl. 254/93 HP

(57) ABSTRACT

Disclosed is an air jack system having at least one air spring with solid plates on each end and an inflatable bag in the center. Each end is capable of attaching to one of multiple devices, and the air spring is operable to push against various items.

### BACKGROUND AND SUMMARY

Disclosed is an air jack system. In various uses the system might provide leveling, absorbing, reserve power, increase power, and/or control functions. The system can be used for positioning, controlling, and/or timing as well, and it is preferably capable of omni-directional operation.

In various embodiments, the system includes an air bag as a controlled pushing device, with attachments relating to the end need of distance, containment, and control. One embodiment would comprise the air bag sitting flat on the ground, pushing upward by air pressure, supplied from a remote location, through a specific attachment. The attachment being one of several, quickly removable for a specific need, from one and/or both ends of the air bag. The movement could be vertical, as in the raising of a tree from the roof of a vehicle, or horizontal, as in pushing a crushed door open (e.g., a “jaws of life” operation). In a jaws of life operation, differential size hinges might be used on the device, depending on the particular application. That is, multiple size hinges might be available and can be interchanged on the device depending on the applications.

Applications of air jack system include center line control of conveyors, hoppers, feeding, loading, carrying from shafts, blocks, bearings, holding with scissors attached to air springs, clamping, positioning to repositioning for new materials or changes to the whole manufacturing processes in a up grade/retrofitting and others.

Additional applications of the air jack leveling include use in industrial production equipment, motor home leveling, RV and fifth wheel leveling, RV tag hitch, boat trailer jack, out board motors on boats to adjust trim, equipment trailers and many other such applications. Bulldozer, heavy dirt equipment, farm equipment or other equipment that conventionally uses 100% hydraulics might be retrofitted with an air spring on either end of a hydraulic cylinder to absorb shock and might additional operate as a computer/valving controlled boost or distance gain in one or more directions. The particular directions might be determined by the specific application. In other embodiments, the air springs might eliminate the hydraulic cylinders all together. Air springs could be used, for example, in the racks on the receiver hitches on the back of cars and pickup trucks to keep a motorcycle from shaking. Race cars could use this system to adjust any direction and angle of tire contact on the fly from the car or pit computer. Other applications are also possible.

When used to raise a car (or other vehicle) and change a tire, the air jack system can be quickly positioned and then operated to raise the car. With conventional jacks, however, the jack must be accurately placed under the vehicle and positioned on the ground in an already level or nearly level manner before it can be lifted. If a car is off the side of the road, it might be very difficult or impossible (thereby leading to having to move the car first) in order to use a conventional jack.

Even so, when the car is raised, if the conventional jack was not level to begin with, then the error might compound as the car is lifted. This might result in an unstable and potentially dangerous final position of the vehicle. In the air jack system, the air jack would not necessarily need to be level to start. As the car is raised, the air jack would automatically operate in multiple directions to level the car, thereby resulting in improved speed and safety for the operator.

One example using wheels and/or castors any one can have an air spring dolly attached to a square or rectangular frame with 4 air springs to quickly place under a vehicle in the blocked freeway to move it out of the way to free up lanes on the freeway.

In one application, emergency personal from policemen to fireman, DOT, can use the air jack systems (such as those with flexible interchangeable systems to quickly interchange attachments). These might be carried in their vehicles for easy accessibility.

All manufacturers of vehicles can replace the dangerous problematic spare tire jack that weighs 10 to 15 #s, space taking and difficult assembly, with a safer more useful way of changing a tire, to helping a police man get a telephone pole off a car with an air jack out of the trunk.

Many current systems for leveling and lifting trailers use electronically control hydraulics. These systems, however, are limited in their range of motion. The present system, however, can have motion not just in one dimension, but can have motion in multiple directions. This can allow for automatic balancing and leveling of the apparatus that is being lifted or otherwise operated on without regard to how the operate positions the air jack system. For example, the air jack system can lift off ball or king pin on a trailer and simultaneously level in multiple or all directions.

### BRIEF DESCRIPTION OF THE DRAWINGS

Various figures are attached showing exemplary air jacks in operations. These figures are intended to be informative, but should not be construed to limit the invention to the embodiments shown therein.

FIG. 1 shows a vehicle with a flat tire before use of the air jack. The figure shows an air hose running under the vehicle to the air jack, and a control valve on the air hose that may be used to control volume and pressure.

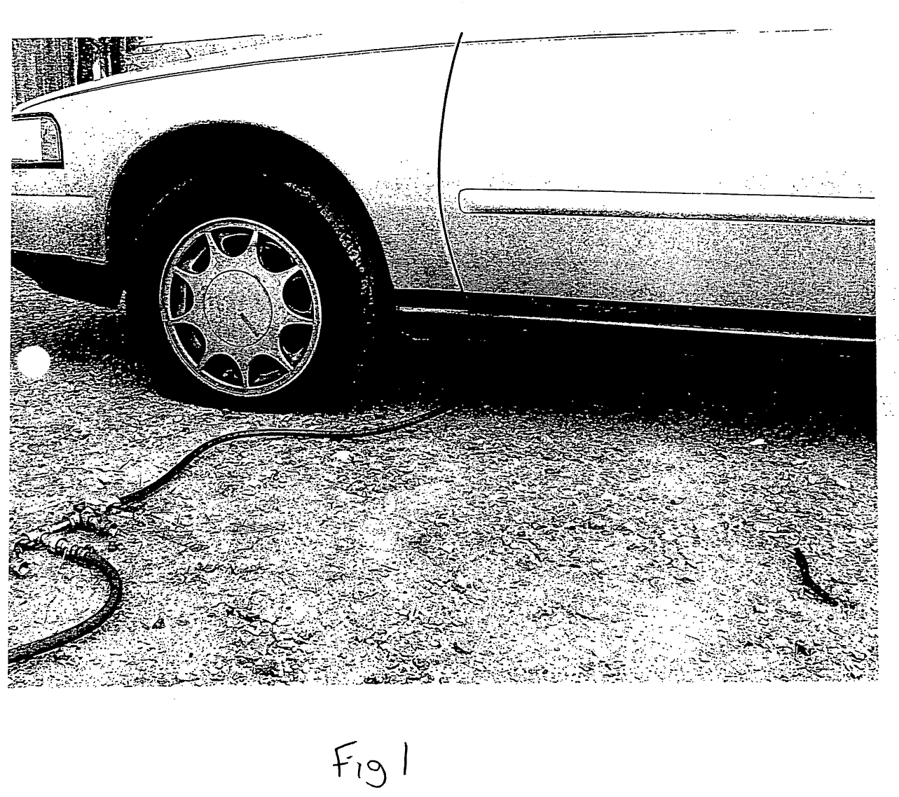

FIG. 2 shows the vehicle of FIG. 1 being lifted with the use of the air jack. The figure shows air hoses running the truck to the two air jacks. Both

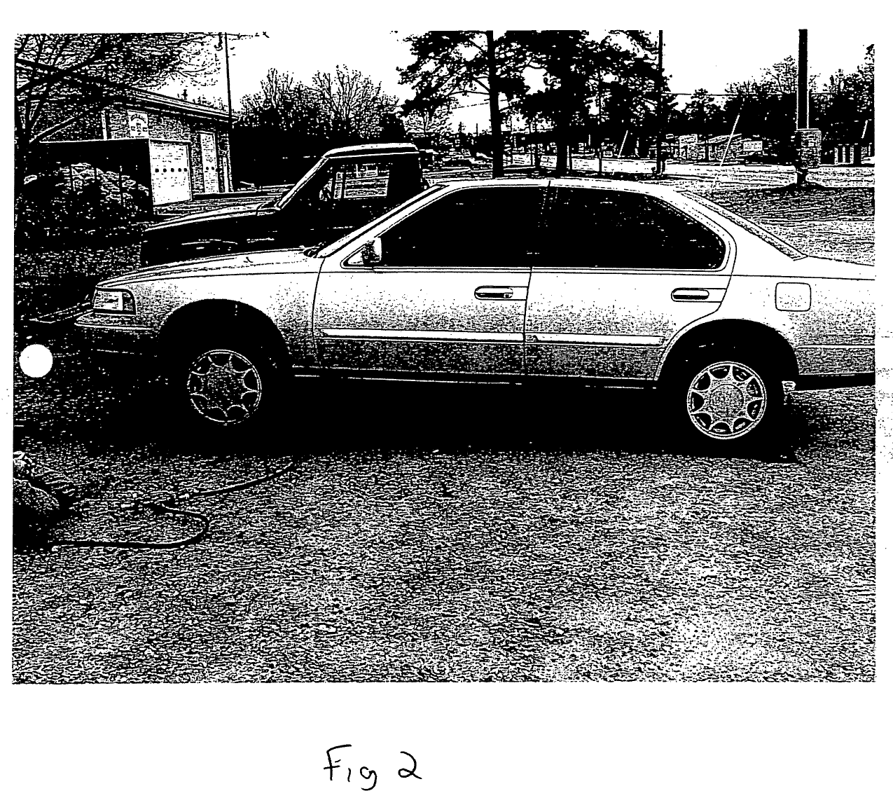

FIG. 3 shows use of a pair of air jacks used to lift a pickup truck.

FIG. 4 shows use of an air jack to lift and stabilize a Fifth-Wheel king pin.

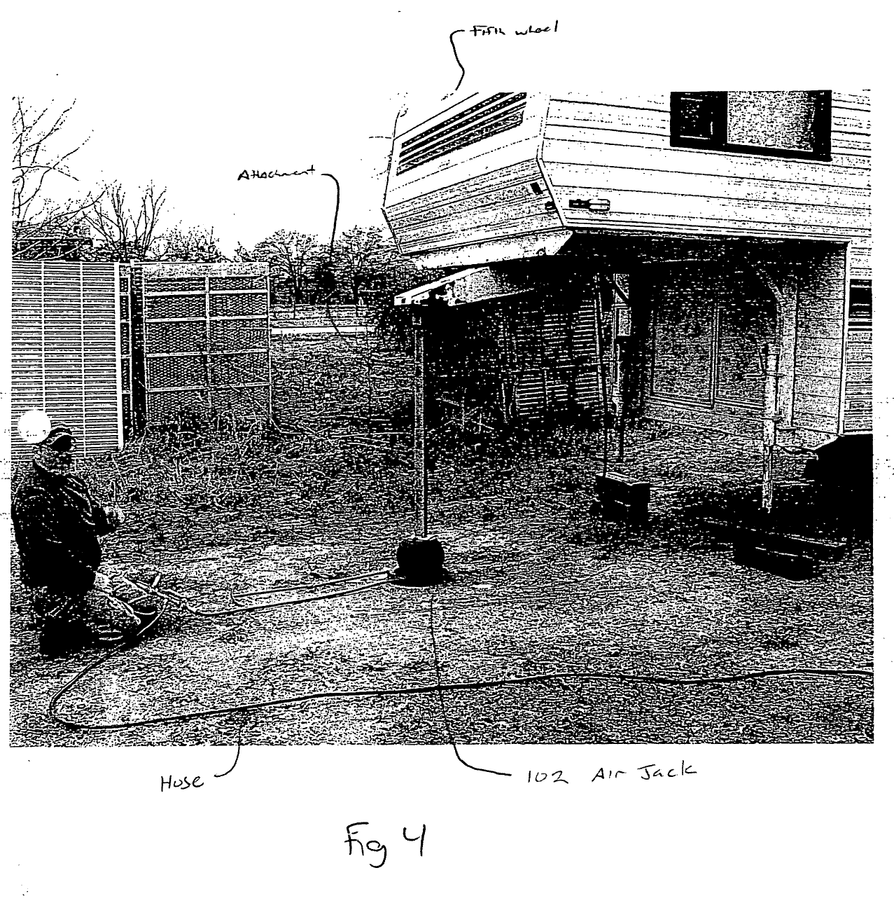

FIG. 5 shows use of an air jack to lift and stabilize a rear portion of the Fifth-Wheel trailer.

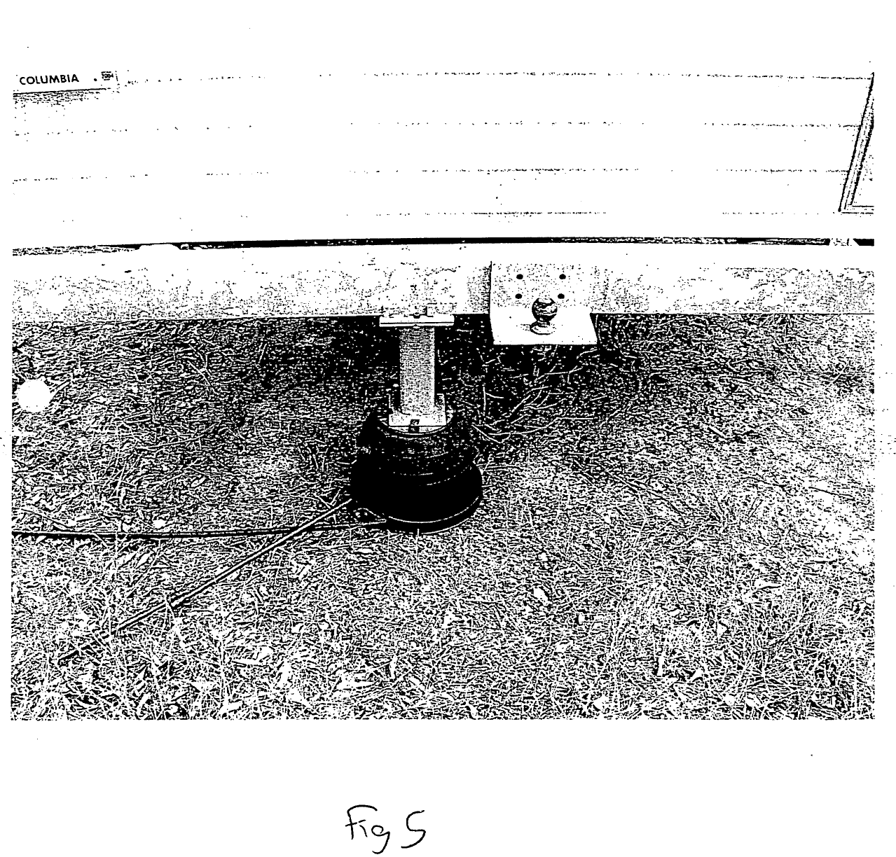

FIGS. 6-8 show use of an air jack mechanism in a jaws of life application.

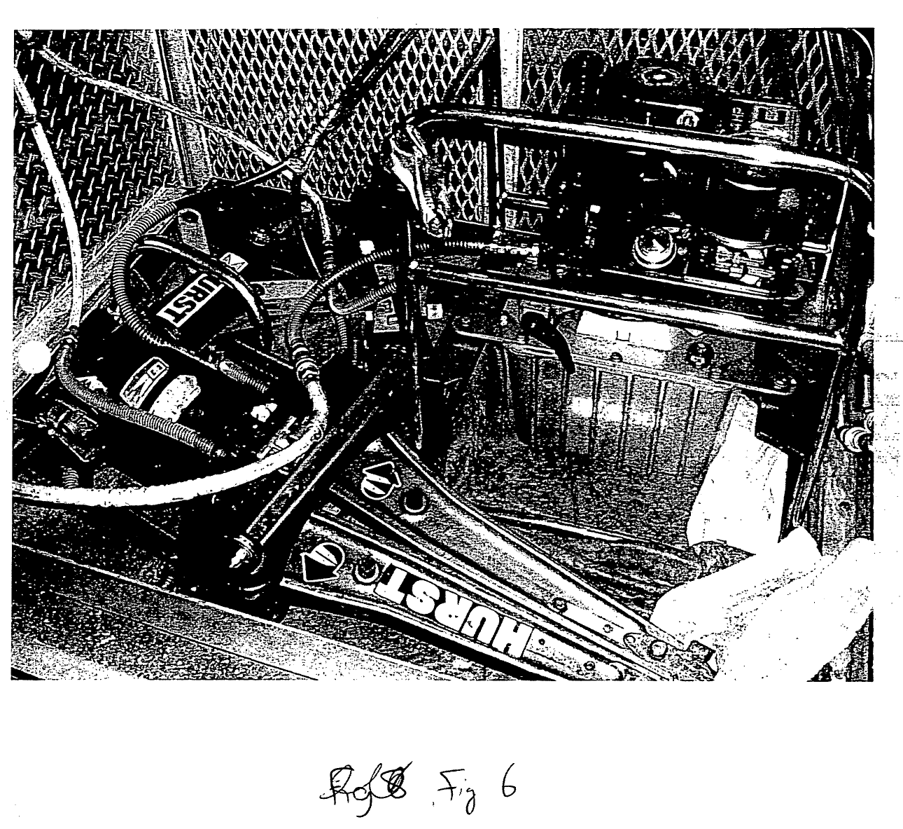

FIG. 9 shows an air jack mechanism with a deflated air bag.

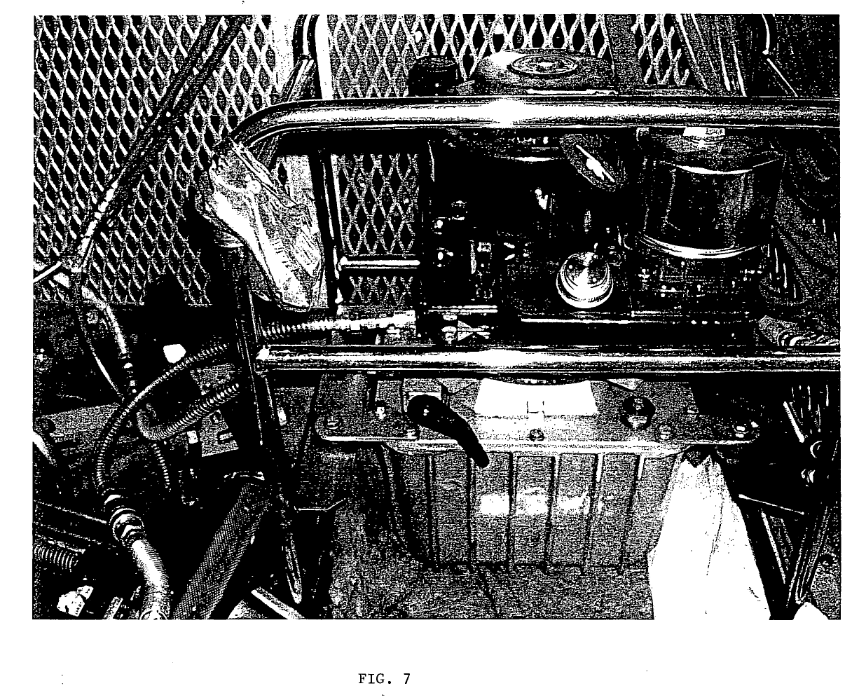

FIG. 10 shows the air jack mechanism with an inflated air bag.

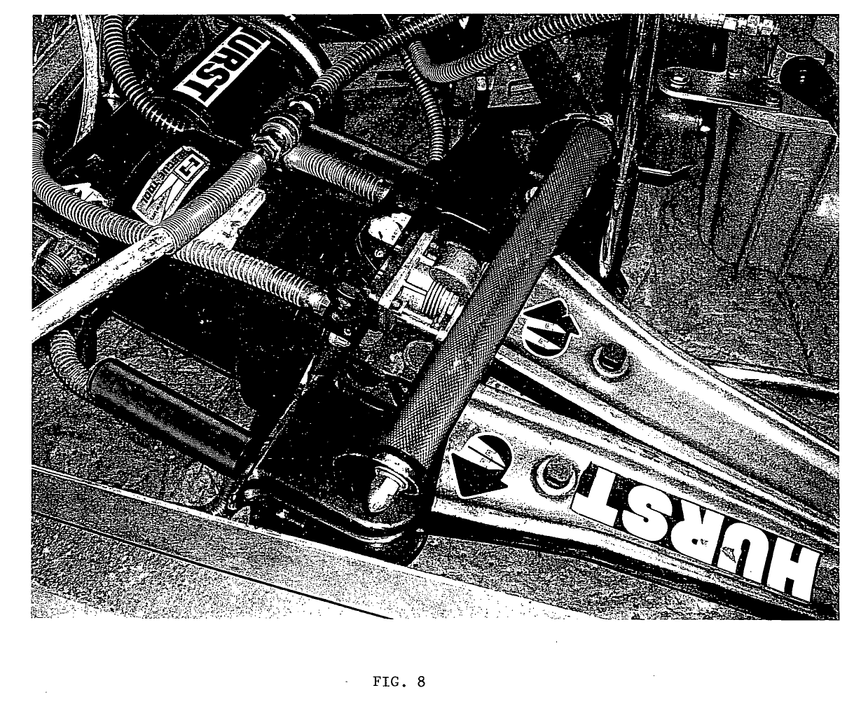

FIG. 11A-D show various attachments for an air jack.

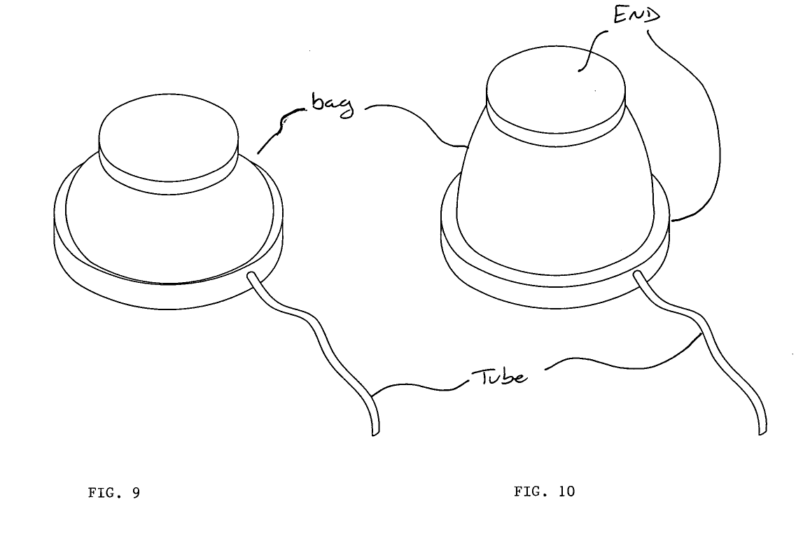

FIG. 12A shows an air jack mechanism with an attachment.

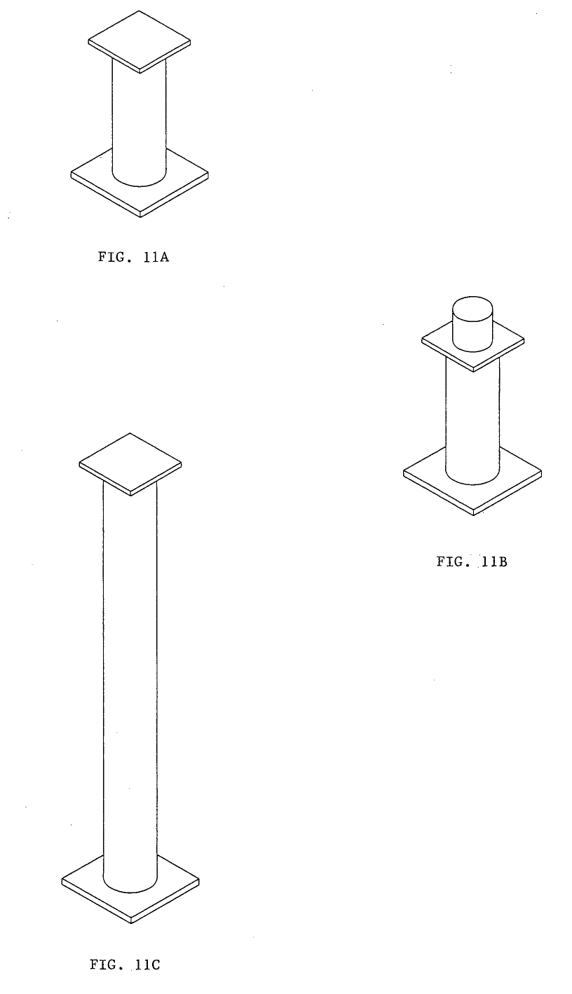

FIG. 12B shows an air jack mechanism with attachments on each of two ends.

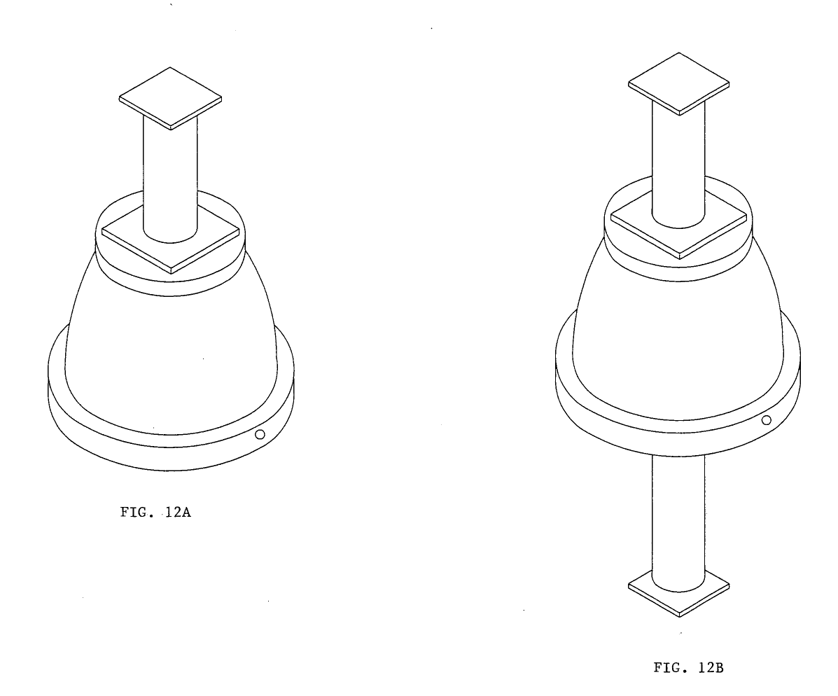

FIG. 13 shows an air jack with a first attachment coupled in a quick-change arrangement. In addition several other attachments are shown.

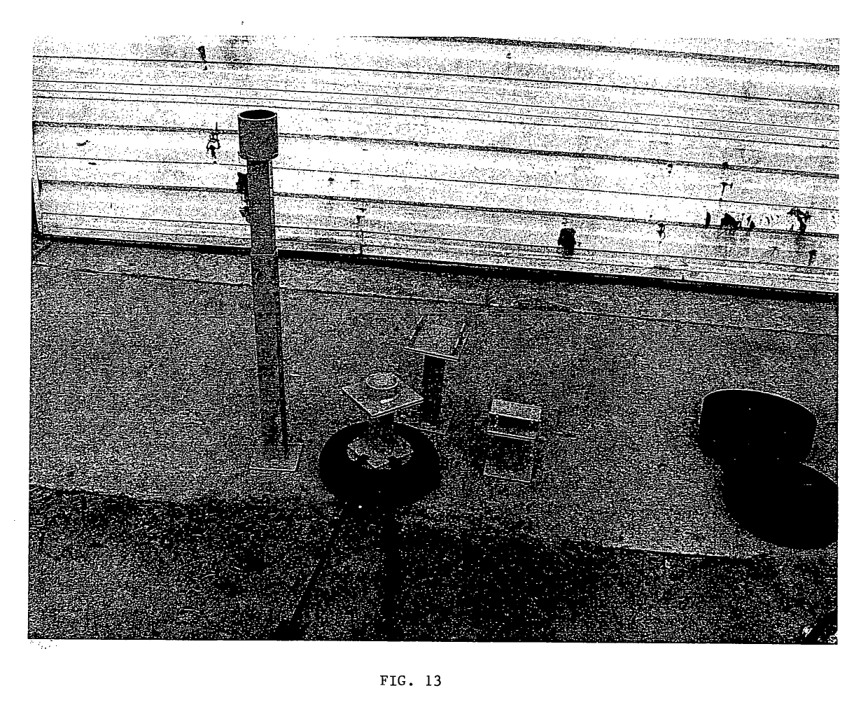

### FURTHER DESCRIPTION

Conventional systems operate at up to 100 pounds of pressure and 4″-5″ lift of useful travel. The air jack system, however, preferably operates at up to 1,000 pounds of pressure and 8″ to 12″ of lift. The air jack system is not limited to these ranges, however, and may operate with a greater or lesser maximum pressure and a greater or lesser range of lift and can have attachments such as a screw jack to make any distance obtainable.

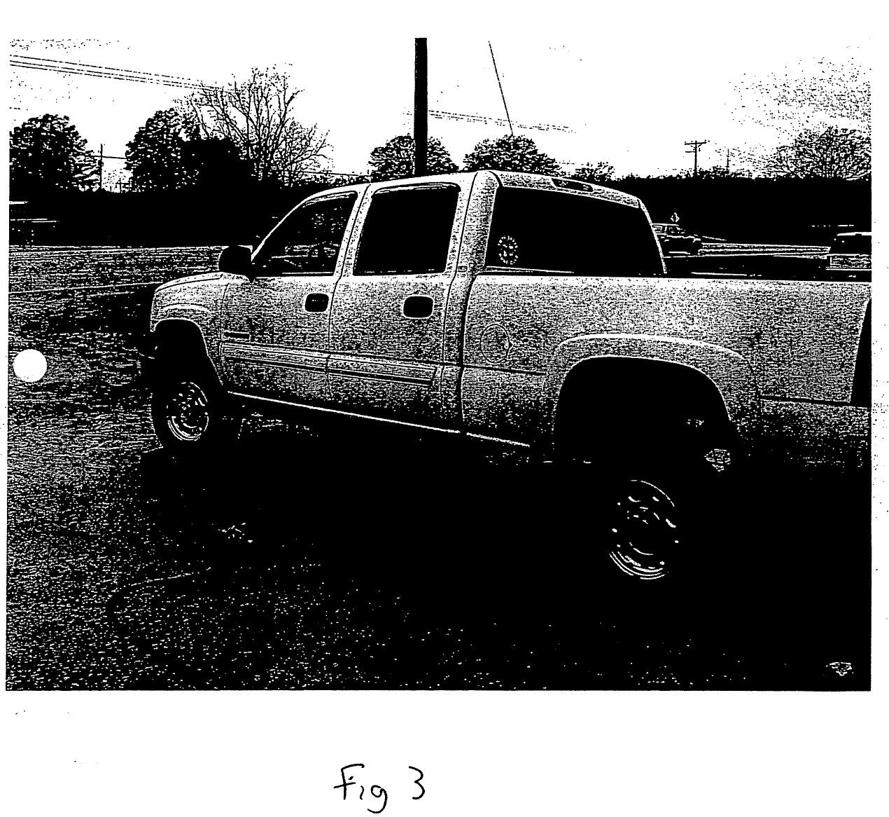

Any number or combination of air jacks can be used simultaneously to lift bodies to desired heights and angles. For instance, in FIG. 3, two jacks are shown lifting a pickup truck to a new angle.

Have more than double the weight lifting capability & stroke of conventional systems can allow the present air spring system to be used omni directionally to not only absorb and reduce shock, but also to accurately adjust for close tolerances in measurements, bending, leveling, adjusting, changing on the fly with no wrenches, adjusting rapidly, accurately, better, cheaper, more power as a back up to all safety systems a extra air springs/jack with sensors as back up.

Now this leads in to cold temperatures and possibly high heat needing more sophisticated sensors that couple with computers, and high heat resistant air spring patents, bulletproof Kevlar etc now being mixed in the rubbers for strength. All the air springs may be configured to work simultaneously with hydraulics.

According to an embodiment, the air jack system may operate as an air spring that has a solid plate on each end. An inflatable bag may be arranged between the solid plates. Each end may also be configured to be attached to any one of a number of multiple devices such as those shown in FIG. 7. When pressurized fluid is supplied to the inflatable bag, the air spring may expand to push against various items. When expanding, for instance, the ends may push against any device coupled thereto.

An air hose may be coupled to the inflatable bag (either directly or indirectly), and/or the system may further comprise an air hose for filling the inflatable bag. The air hose may be coupled to an external pump that supplies air to the inflatable bag through the air hose. In alternative uses, the hose may supply other fluids, potentially including liquids to convert the air spring into a hydraulic spring.

Valves may be available at one or more locations to enable different amounts and pressures to inflate and deflate the bag. As shown in the figures, the valves may be in the air hose or other locations.

One or more handles may be attached to the air spring to facilitate maneuvering the system into position. Handles may also be attached to the various air spring attachments. A retaining mechanism may also be included to help ensure that the air spring maintains its position.

1. A system comprising:
an air spring having an end solid plate on each end and an inflatable bag disposed between the plates, wherein at least one end is configured to couple with an attachment, and wherein the air spring is operable to push against various items.

2. The system of claim 1, further comprising an air hose for filling said inflatable bag.

3. The system of claim 2, wherein the air hose delivers one or more of the following constituents: oxygen, nitrogen, carbon dioxide or ambient air.

4. The system of claim 1, further comprising one or more control valves for at least partially controlling inflation and deflation of the inflatable bag.

5. The system of claim 1, further comprising a handle attached to the air springs.

6. The system of claim 1, further comprising a retaining mechanism for retaining and/or maintaining position of the system.

7. A system comprising:
a dolly;
one or more air springs attached to the dolly; and
one or more frames attached to the one or more air springs.

8. The system of claim 7, wherein the dolly is configured to with four air springs;

9. The system of claim 7, wherein when bags of the air springs are deflated, the dolly may be placed under an automobile.

10. The system of claim 9, wherein when bags of the air springs are inflated, the automobile may be lifted off of the ground.

11. A system comprising:
at least one spring having solid plates on each end and an inflatable bag in the center, wherein each end is capable of attaching to one of multiple devices, and wherein the air spring is operable to push against various items.
